(19) United States
(12) Patent Application Publication
(10) Pub. No.: US 2012/0088620 A1
(43) Pub. Date: Apr. 12, 2012

(54) MACHINE TOOL DEVICE

(76) Inventor: Dietmar Saur, Gomaringen (DE)

(21) Appl. No.: 13/255,060

(22) PCT Filed: Nov. 25, 2009
(86) PCT No.: PCT/EP2009/065803

§ 371 Date: Nov. 14, 2011

(30) Foreign Application Priority Data
Mar. 11, 2009 (DE) 102009001470.5

(51) Int. Cl. F16H 3/72; F16H 1/28; F16H 1/00

(52) U.S. Cl. 475/1; 74/665 R

(57) ABSTRACT

A machine tool device, in particular a hand machine tool device, having a gear system that has a first input element. The gear system has at least one second input element.

### BACKGROUND INFORMATION

The present invention relates to a machine tool device.

A conventional machine tool device, in particular a conventional hand machine tool device, may have a gear system that has an input element.

### SUMMARY

In accordance with an example embodiment of the present invention, a machine tool device is provided, in particular a hand machine tool device, having a gear system that has a first input element.

In accordance with an example embodiment, the gear system has at least one second input element. Advantageously, the first and/or the second input element are connected to a motor of the machine tool device. An “input element” is to be understood in particular as an element that is provided to introduce a torque into the gear system and/or to transmit a torque to the gear system. Advantageously, the gear system additionally has an output element. The output element is provided to further transmit a torque to a tool spindle and/or to a tool connected to a machine tool. In this context, “torque” is to be understood in particular as also meaning a rotational power. “Provided” is to be understood in particular as meaning specifically equipped and/or designed. The example design according to the present invention of the machine tool device enables a continuously adjustable gear ratio between a motor of the machine tool and the tool, whereby the rotational speed and the torque applied to the tool can particularly advantageously be modified while under load.

In a further example construction, the gear system may have at least one planetary gearing. A “planetary gearing” is to be understood in particular as a gear mechanism having at least one ring gear, a sun gear, and a planet gear bearer and planet gears. The planetary gearing enables a constructively simple linkage of two torques introduced through the first and the second input element.

In addition, the first input element may be connected in rotationally fixed fashion to a sun gear of the gear system. Alternatively, the first input element is fashioned as a sun gear of the first planetary gearing. Through the first input element, connected in rotationally fixed fashion to the sun gear, a particularly advantageous gear reduction can be achieved, enabling use of an economical fast-running motor.

In addition, the second input element may be connected in rotationally fixed fashion to a ring gear of the gear system. Advantageously, the input element is at least partly fashioned in one piece with the second input element. Also advantageously, the second input element is fashioned as a ring gear of the first planetary gearing. Particularly advantageously, the second input element is fashioned as a ring gear of a second planetary gearing. Through the second input element, fashioned as a ring gear, the second input element and a motor can be connected in a constructively simple manner.

In addition, the machine tool device has a first motor whose rotor is connected in rotationally fixed fashion to the first input element. The first motor can advantageously introduce a torque into the machine tool device.

In an advantageous embodiment of the present invention, the machine tool device has a second motor whose rotor is connected in rotationally fixed fashion to the second input element. The second motor can advantageously cover, and thus manage, load peaks that occur for example when a tool is tilted during operation.

In a further example embodiment, it is provided that the rotor of the second motor is fashioned at least partly in one piece with the second input element. The expression “partly in one piece” is to be understood as meaning that at least one component is a functional element of the motor and at the same time is a functional element of the input element. The rotor fashioned partly in one piece with the second input element makes it possible to save components and space in a constructively simple manner, so that the machine tool device is particularly small, light, and economical.

In addition, the machine tool device may have a control and/or regulating unit that is provided to operate at least one motor as a generator. The expression “operate as a generator” is to be understood in particular as meaning that in at least one operating state the motor converts a rotational power into electrical power. “Provided” is also to be understood as meaning specifically programmed. Through the use of one of the motors as a generator, the machine tool device can operate in a particularly energy-efficient manner, thus prolonging the useful life of an accumulator unit. In addition, in this way energy consumption can be reduced during mains operation. In addition, the electrical power of the motor operated as a generator can be intermediately stored in an accumulator unit and/or a storage unit.

In addition, the machine tool device may have a control and/or regulating unit that is provided to cause a change in the direction of rotation in at least one motor. Advantageously, this control and/or regulating unit is fashioned at least partly in one piece with the control and/or regulating unit that is provided in order to operate at least one motor as a generator. A “change in direction of rotation” is to be understood in particular as a change in the sense of rotation of the motor. Advantageously, the control and/or regulating unit is provided to effect a change in direction of rotation in two motors independently of one another. Through the change of direction of rotation, advantageously a particularly large gear ratio range of the gear system can be achieved, so that the rotational speed and torque of the tool can be flexibly adapted.

In addition, the gear system may effect a gear reduction between at least one input element and an output element, whereby advantageously a fast-rotating motor can be used that is lighter and more economical than a slow-rotating motor.

In addition, the gear system may have at least one additional, secondary planetary gearing. Preferably, the second input element is fashioned at least partly in one piece with a ring gear of the second planetary gearing. Through the second planetary gearing, a particularly flexible and large gear reduction can be achieved.

In a further embodiment, a planet gear bearer of the first planetary gearing is connected in rotationally fixed fashion to a sun gear of the second planetary gearing; in this way, a particularly space-saving and advantageous gear reduction can be achieved in a constructively simple manner.

In addition, the gear system may have at least one third planetary gearing; in this way, a gear system can be achieved that can be used in a particularly versatile manner.

In addition, a planet gear bearer of the second planetary gearing may be connected in rotationally fixed fashion to a sun gear of the third planetary gearing; in this way, a particularly space-saving and advantageous gear reduction can be achieved in a constructively simple manner.

In addition, in accordance with an example embodiment of the present invention, a machine tool is provided, in particular a hand machine tool, having a machine tool device or a hand machine tool device, in which all machine tools that appear useful to those skilled in the art, such as in particular drills, hammer drills, saws, planers, screwdrivers, mills, grinders, angle grinders, and/or multifunction tools, are possible for operation with a machine tool device or a hand machine tool device; in this way, a particularly efficient and flexible machine tool or hand machine tool can be provided.

### BRIEF DESCRIPTION OF THE DRAWINGS

Additional advantages result from the description below. The figures show two exemplary embodiments of the present invention. The figures and the description contain numerous features in combination. A person skilled in the art will usefully also regard the features individually and combine them to form useful further combinations.

FIG. 1 shows a machine tool having a machine tool device according to an example embodiment of the present invention.

FIG. 2 shows the machine tool device of FIG. 1, having a gear system.

FIG. 3 shows a machine tool device having an alternative gear system, having a rotor fashioned in one piece with the second input element.

### DETAILED DESCRIPTION OF EXAMPLE EMBODIMENTS

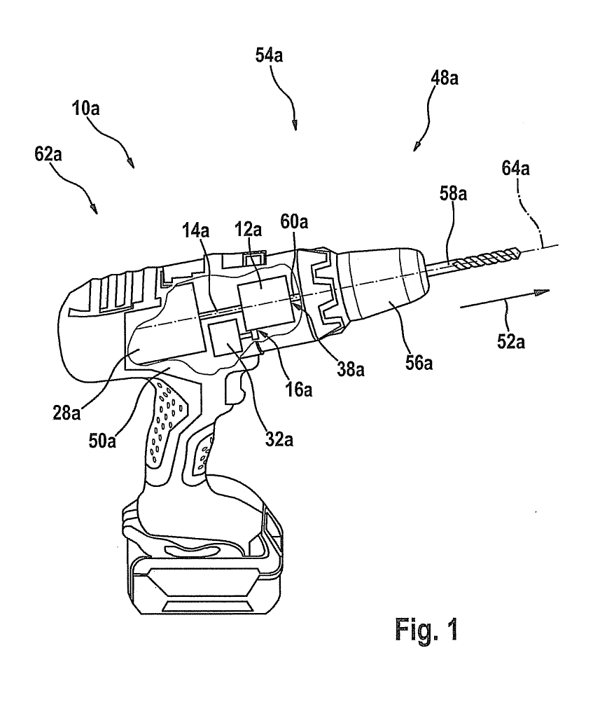

FIG. 1 shows, in a schematic representation, a machine tool 48a fashioned as a handheld cordless drill/driver, having a pistol-grip machine tool housing 50a. In a front (in a main working direction 52a of machine tool 48a) region 54a of machine tool 48a, machine tool 48a has a tool chuck 56a and a tool 58a that can be fastened in tool chuck 56a. Tool chuck 56a is connected in rotationally fixed fashion to a schematically shown tool spindle 60a of machine tool 48a. Machine tool 48a has a machine tool device 10a that is fashioned as a hand machine tool device and that has a gear system 12a. Gear system 12a has a first input element 14a and a second input element 16a.

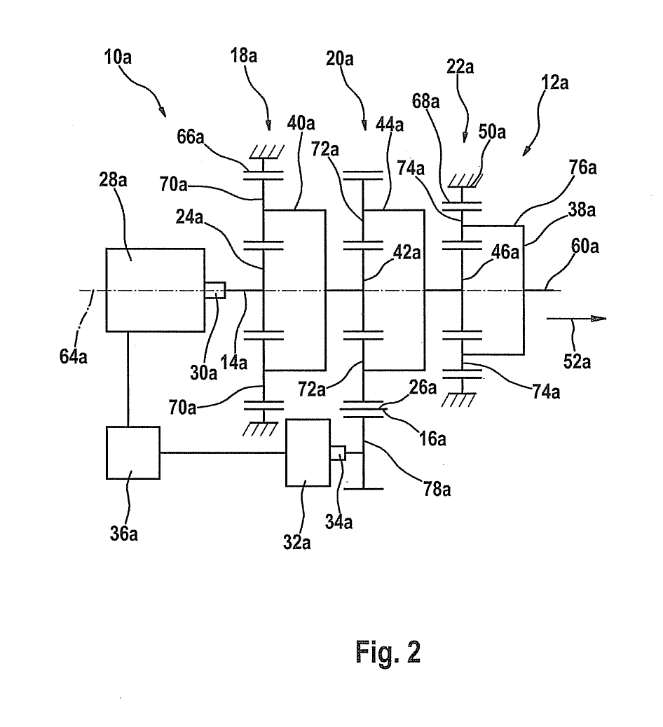

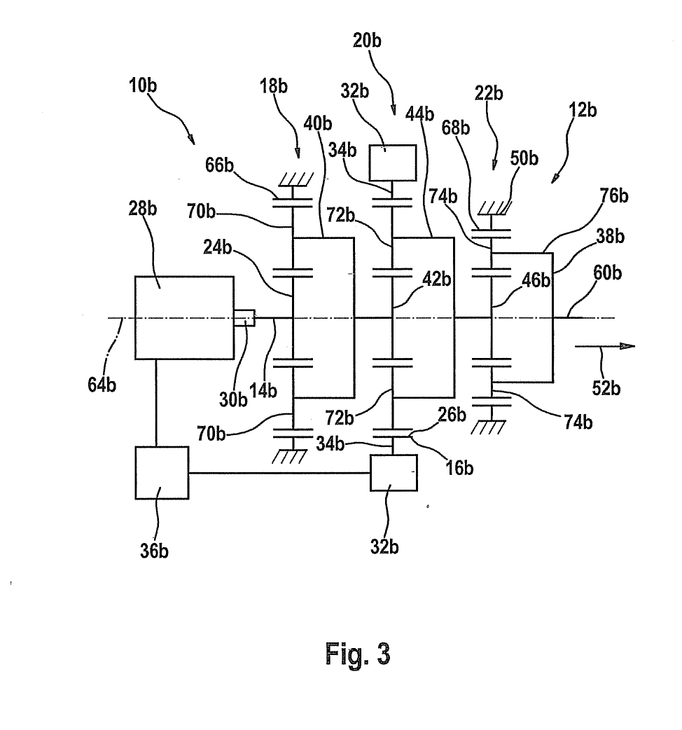

FIG. 2 shows gear system 12a of machine tool device 10a in a schematic representation. Machine tool device 10a has a first motor 28a and a second motor 32a, fashioned as electric motors. First motor 28a is situated in a rear region 62a, facing away from tool chuck 56a, of machine tool 48a, and is connected in rotationally fixed fashion on a stator to machine tool housing 50a. In FIG. 2 and FIG. 3, machine tool housing 50a is provided only once with a reference character for the sake of clarity. An axis of rotation of first motor 28a corresponds to an axis of rotation 64a of tool chuck 56a. A rotor 30a of first motor 28a is connected in rotationally fixed fashion to first input element 14a. First input element 14a is fashioned as an input shaft.

Gear system 12a has a first, a second, and a third planetary gearing 18a, 20a, 22a; i.e., it has a three-stage planetary gearing. The three planetary gearings 18a, 20a, 22a are situated one after the other along axis of rotation 64a of tool 58a, third planetary gearing 22a facing tool 58a, and second planetary gearing 20a being situated between first planetary gearing 18a and third planetary gearing 22a. Each planetary gearing 18a, 20a, 22a has a sun gear 24a, 42a, 46a, a ring gear 26a, 66a, 68a, four planet gears 70a, 72a, 74a, of which two are shown in each case, and a planet gear bearer 40a, 44a, 76a. In addition, each planetary gearing 18a, 20a, 22a has a planet gear bearer 40a, 44a, 76a that guides planet gears 70a, 72a, 74a along a circular path about axis of rotation 64a of planet gear bearer 40a, 44a, 76a. Planet gears 70a of first planetary gearing 18a mesh with sun gear 24a and ring gear 66a of first planetary gearing 18a, and are rotatably mounted on the planet gear bearer of first planetary gearing 18a. Second planetary gearing 20a and third planetary gearing 22a are constructed in a corresponding manner. First input element 14a of gear system 12a is connected in rotationally fixed fashion to sun gear 24a of first planetary gearing 18a. First planetary gearing 18a thus effects a gear reduction between first input element 14a and its planet gear bearer 40a.

Second input element 16a of gear system 12a is realized as an outer toothing, and is connected in rotationally fixed fashion to ring gear 26a of second planetary gearing 20a. Alternatively, second input element 16a can also be connected in rotationally fixed fashion to planet gear bearer 44a of second planetary gearing 20a. Ring gear 66a of first planetary gearing 18a is connected in rotationally fixed fashion to machine tool housing 50a. Planet gear bearer 40a of first planetary gearing 18a is connected in rotationally fixed fashion to sun gear 42a of second planetary gearing 20a.

In this first exemplary embodiment, a rotor 34a of second motor 32a is connected, by a spur gear 78a, to ring gear 26a of second planetary gearing 20a, i.e., to second input element 16a, in that second input element 16a meshes with spur gear 78a. Spur gear 78a is connected in rotationally fixed fashion to rotor 34a of second motor 32a. Planet gear bearer 44a of second planetary gearing 20a is connected in rotationally fixed fashion to ring gear 46a of third planetary gearing 22a. Alternatively, ring gear 26a of second planetary gearing 20a can be connected in rotationally fixed fashion to sun gear 46a of third planetary gearing 22a.

Using second input element 16a, or ring gear 26a, of second planetary gearing 20a, said element being capable of being rotated by second motor 32a, a gear ratio of second planetary gearing 20a can be altered. If second motor 32a, and thus ring gear 26a of second planetary gearing 20a, are standing still, second planetary gearing 20a effects a reduction of rotational speed between sun gear 42a and planet gear bearer 44a of second planetary gearing 20a. If second motor 32a causes a rotation of sun gear 26a of second planetary gearing 20a in the same direction in which first motor 28a is rotating, the rotational speed reduction is less than in the case in which ring gear 26a of second planetary gearing 20a is stationary. If second motor 32a causes a rotation of ring gear 26a of second planetary gearing 20a in the direction opposite that in which first motor 28a is rotating, the rotational speed reduction is greater than in the case in which ring gear 26a of second planetary gearing 20a is stationary, and can attain negative values, i.e., tool spindle 60a rotates in the direction opposite that of first motor 28a.

Ring gear 68a of third planetary gearing 22a is connected in rotationally fixed fashion to machine tool housing 50a. Gear system 12a has an output element 38a. Planet gear bearer 76a of third planetary gearing 22a is fashioned as this output element 38a, and is connected in rotationally fixed fashion to tool spindle 60a. Third planetary gearing 22a thus effects a gear reduction between third sun gear 46a and output element 38a. Overall, gear system 12a effects a gear reduction between first input element 14a and output element 38a.

Machine tool device 10a has a control and/or regulating unit 36a that is provided to effect a change of direction of rotation in second motor 28a. Via this change of direction of rotation, the direction of rotation of second ring gear 26a can be reversed. In addition, control and/or regulating unit 36a is provided to operate second motor 32a as a generator. In this way, it is possible, given a direction of rotation of first motor 28a that is opposite to the direction of rotation of second ring gear 26a, to reduce the power consumption of machine tool device 10a. In addition, control and/or regulating unit 36a is provided for the continuous regulation of the rotational speed of the two motors 28a, 32a.

FIG. 3 shows another exemplary embodiment of the present invention. In order to distinguish the exemplary embodiments, the letter a in the reference characters of the exemplary embodiment shown in FIGS. 1 and 2 is replaced by the letter b in the reference characters of the exemplary embodiment shown in FIG. 3. The following description is essentially limited to the differences from the exemplary embodiment shown in FIGS. 1 and 2, so that reference can be made to the description of the exemplary embodiment shown in FIGS. 1 and 2 with regard to components, features, and functions that remain the same.

FIG. 3 shows a machine tool device 10b having a gear system 12b and a second motor 32b, whose rotor 34b is connected in rotationally fixed fashion to a second input element 16b. Second input element 16b is fashioned in one piece with a ring gear 26b of a second planetary gearing 20b. Rotor 34b of second motor 32b is fashioned partly in one piece with second input element 16b. Ring gear 26b of second planetary gearing 20b acts as a motor shaft of second motor 32b. Second motor 32b is situated in circular fashion about an axis of rotation 64b of a tool chuck 56a. First input element 14b is connected, as in the first exemplary embodiment, to first motor 28b and to sun gear 24b of first planetary gearing 18a.

Other gear systems, in particular having one or two planetary gearings, that appear useful to those skilled in the art are also possible. Other useful connections of the planetary gearings among one another are also possible.

1-15. (canceled)

16. A hand machine tool device including a gear system having a first input element and at least one second input element.

17. The machine tool device as recited in claim 16, wherein the gear system includes at least one planetary gearing.

18. The machine tool device as recited in claim 17, wherein the first input element is connected in rotationally fixed fashion to a sun gear of the gear system.

19. The machine tool device as recited in claim 18, wherein the second input element is connected in rotationally fixed fashion to a ring gear of the gear system.

20. The machine tool device as recited in claim 16, further comprising:
a motor having a rotor which is connected in rotationally fixed fashion to the first input element.

21. The machine tool device as recited in claim 16, further comprising:
a motor having a rotor connected in rotationally fixed fashion to the second input element.

22. The machine tool device as recited in claim 21, wherein the rotor of the motor is fashioned at least partly in one piece with the second input element.

23. The machine tool device as recited in claim 21, further comprising:
at least one of a control and regulating unit to operate at least one motor as a generator.

24. The machine tool device as recited in claim 21, further comprising:
at least one of a control and regulating unit to effect a change in a direction of rotation in at least one motor.

25. The machine tool device as recited in claim 16, wherein the gear system effects a gear reduction between the first input element and an output element of the gear system.

26. The machine tool device as recited in claim 17, wherein the gear system further comprises at least one additional, second planetary gearing.

27. The machine tool device as recited in claim 26, wherein a planet gear bearer of the first planetary gearing is connected in rotationally fixed fashion to a sun gear of the second planetary gearing.

28. The machine tool device as recited in claim 26, wherein the gear system has at least one additional third planetary gearing.

29. The machine tool device as recited in claim 28, wherein a planet gear bearer of the second planetary gearing is connected in rotationally fixed fashion to a sun gear of the third planetary gearing.

30. A hand machine tool, comprising:
a machine tool device including a gear system having a first input element and at least one second input element.
